(19) United States
(12) Patent Application Publication
(10) Pub. No.: US 2022/0337980 A1
(43) Pub. Date: Oct. 20, 2022

(54) COMMUNICATION SYSTEM FOR TRANSPORT MEANS

(71) Applicant: TOYOTA JIDOSHA KABUSHIKI KAISHA, Toyota-shi (JP)

(72) Inventors: Kaoru YOSHIDA, Nisshin-shi (JP); Shiori FURUTA, Toyota-shi (JP)

(73) Assignee: TOYOTA JIDOSHA KABUSHIKI KAISHA, Toyota-shi (JP)

(21) Appl. No.: 17/655,817

(22) Filed: Mar. 22, 2022

(30) Foreign Application Priority Data
Apr. 19, 2021 (JP) 2021-070293

(51) Int. Cl. H04W 4/40; H04W 8/22; H04W 24/08; H04B 10/114

(52) U.S. Cl. CPC H04W 4/40; H04W 8/22; H04W 24/08; H04B 10/114

(57) ABSTRACT

A communication system for transport means is provided, by which wireless communication with high quality is realized in the interior of the transport means. A communication device to mainly perform optical wireless communication with a terminal device 2 is selected among a plurality of light source devices 3A, 3B and 3C capable of performing optical wireless communication with the terminal device 2 based on a state of an occupant in the interior of the transport means. In this way, the wireless communication with high quality is realized, as the whole system, between the terminal device 2 and the plurality of light source devices 3A, 3B and 3C.

### CROSS-REFERENCE TO RELATED APPLICATIONS

The present application claims priority under 35 U.S.C. § 119(a) to Japanese Patent Application No. 2021-070293, filed on Apr. 19, 2021. The contents of this application are incorporated herein by reference in its entirety.

### TECHNICAL FIELD

The present invention relates to a communication system for transport means. Especially, the present invention relates to improvement to obtain wireless communication with high quality in the interior of transport means such as an automobile.

### BACKGROUND ART

Conventionally, a communication system as disclosed in Patent Document 1 is known, by which a terminal device in the interior of transport means performs wireless communication with a communication device connected to a communication network.

In the communication system disclosed in Patent Document 1, an interior lamp with communication function, which is connected to a wired communication network, includes an LED that transmits information (signals) to a seat and a display device by visible light communication. Also, the seat and the display device each include: a light receiving part that receives information transmitted from the interior lamp with communication function; and a control part that controls its proper operations based on the information received by the light receiving part. In this way, it is possible to perform wireless communication (in Patent Document 1, optical wireless communication) between the interior lamp with communication function, and the seat and the display device in the interior the vehicle.

### PRIOR ART DOCUMENT

### Patent Document

[Patent Document 1] JP 2020-083172 A

### SUMMARY OF THE INVENTION

### Problem to be Solved by the Invention

When the wireless communication is performed between the terminal device and the communication device in the interior of the transport means, there is a high possibility that any obstacles (occupants and/or objects) exist between the terminal device and the communication device to interfere with the communication, since the interior of the transport means is generally a relatively small space. Consequently, the quality of the wireless communication may be degraded due to the obstacles. Thus, there is a room for realizing wireless communication with high quality in the interior of the transport means.

The present invention was made in consideration of the above circumstances, an object of which is to provide a communication system for transport means that realizes wireless communication with high quality in the interior of the transport means.

### Means for Solving the Problem

In order to achieve the above object, a communication system for transport means of the present invention includes: a plurality of communication devices performing wireless communication with a terminal device in an interior of the transport means; a detection part detecting a state of an occupant in the interior of the transport means; and a control part selecting a communication device to mainly perform the wireless communication with the terminal device, among the plurality of communication devices, based on the state of the occupant in the interior of the transport means, which is detected by the detection part.

With the configuration capable of performing wireless communication between the terminal device and a plurality of communication devices, it is possible to perform high-speed (high-quality) communication. More specifically, the so-called MIMO (Multi Input Multi Output) method can be used for the high-quality communication. However, depending on the state of an occupant in the interior of the transport means, the occupant may serve as an obstacle to interfere with the communication between the terminal device and a certain communication device. In the present invention made in consideration of the above problem, the state of the occupant in the interior of the transport means is detected by the detection part so as to extract a communication device capable of performing high-quality communication (or a communication device estimated to perform high-quality communication) with the terminal device among the plurality of communication devices. Thus, the extracted communication device is selected as the communication device to mainly perform wireless communication with the terminal device. In this way, it is possible to realize, as the whole system, the wireless communication with high quality between the terminal device and the plurality of communication devices.

The detection part includes at least one of the following: a seating sensor detecting whether the occupant is sitting in a seat provided in the interior of the transport means; a seat belt sensor detecting whether a seat belt provided on the seat is worn; and an inside camera taking an image of the interior of the transport means.

With the above configuration, it is possible to accurately detect the position of the occupant in the interior of the transport means, which leads to correct determination with which communication device among the plurality of communication devices the occupant interferes. As a result, it is possible to improve reliability of the selection of the communication device that mainly performs the wireless communication with the terminal device.

Also, operations to evaluate communication quality of the wireless communication between the terminal device and the communication device selected by the control part are performed, and a result of the operations to evaluate the communication quality is fed back to the control part.

With the above configuration, it is possible that the control part performs operations to ameliorate the communication quality depending on the result of the operations to evaluate the communication quality, which is fed back to the control part.

Specifically, when the control part determines that a predetermined communication quality is not obtained based on the result of the operations to evaluate the communication quality, which is fed back to the control part, the control part sequentially performs the operations to evaluate the communication quality of the wireless communication between the terminal device and each of the plurality of communication devices until the predetermined communication quality is obtained. Thus, the control part selects a communication device that wirelessly communicates with the terminal device when the predetermined communication quality is obtained as the communication device to mainly perform the wireless communication with the terminal device.

With the above configuration, it is possible to select the communication device that achieves the predetermined communication quality with the terminal device among the plurality of communication devices. As a result, it is possible to improve reliability of the wireless communication with high quality between the terminal device and the communication device.

Specifically, the wireless communication performed between the terminal device and each of the plurality of communication devices is optical wireless communication.

The optical wireless communication can realize high-speed communication. Also, since the optical wireless communication does not cause radio interference, stable communication can be achieved. Furthermore, since the optical wireless communication does not generate any electromagnetic wave, electronic devices mounted on the transport means are not affected, which leads to realization of high-speed and stable communication with the terminal device in the interior of the transport means.

### Advantageous Effect of the Invention

In the present invention, a communication device to mainly perform wireless communication with a terminal device is selected, among a plurality of communication devices capable of performing wireless communication with the terminal device, based on a state of an occupant in the interior of transport means. In this way, the wireless communication with high quality is realized, as the whole system, between the terminal device and the plurality of communication devices.

### BRIEF DESCRIPTION OF THE DRAWINGS

FIG. 1 is a diagram schematically illustrating a configuration of a vehicle communication system according to an embodiment.

FIG. 2 is a block diagram indicating the vehicle communication system.

FIG. 3 is a diagram illustrating an example of installation locations of in-vehicle light source devices.

FIG. 4 is a schematic diagram explaining a communication state in the vehicle.

FIG. 5 is a flowchart indicating a procedure of operations to select a light source device.

FIG. 6 is a schematic diagram indicating the communication state between the light source device and the terminal device before the operations to select the light source device are completed.

FIG. 7 is a schematic diagram indicating the communication state between the light source device and the terminal device after the operations to select the light source device are completed.

FIG. 8 is a flowchart indicating a procedure of operations to select the light source device according to a variation.

### DESCRIPTION OF EMBODIMENTS

Hereinafter, an embodiment of the present invention will be described with reference to the drawings. In this embodiment, the communication system for transport means of the present invention is applied to an automobile. Therefore, in this embodiment, the communication system for transport means is expressed as a “vehicle communication system”, and the interior of the transport means is expressed as an “interior of a vehicle (in-vehicle)”. Also, as to a wireless communication mode in the interior of a vehicle, an example is described, in which optical wireless communication (Li-Fi: Light Fidelity) is used. Also as the in-vehicle wireless communication mode of the present invention, Bluetooth (registered trademark) or Wi-Fi (registered trademark) may be used.

Also in this embodiment, an example is described, in which the vehicle communication system is built as a communication mode in which information can be sent and received reciprocally (hereinafter occasionally referred to as “two-way communication”) between a terminal device in the interior of a vehicle and the outside of the vehicle (for example, internet; more specifically, a server of an internet service provider, which is being connected to the internet). However, the technical idea of the present invention is not limited to the vehicle communication system in which the two-way communication is performed, but includes the system that is built such that the terminal device only receives information from the outside of the vehicle (hereinafter occasionally referred to as “one-way communication).

—Overall Configuration of Vehicle Communication System—

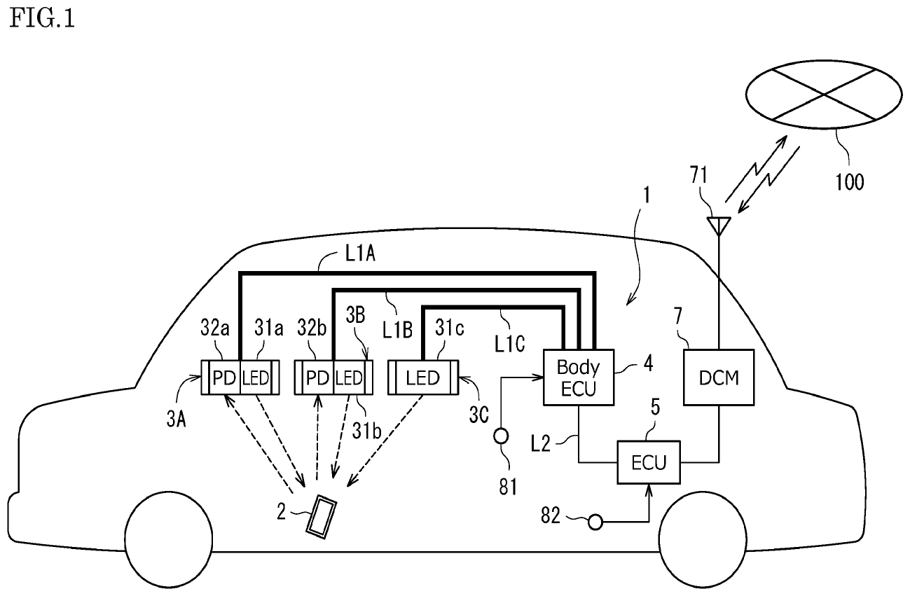

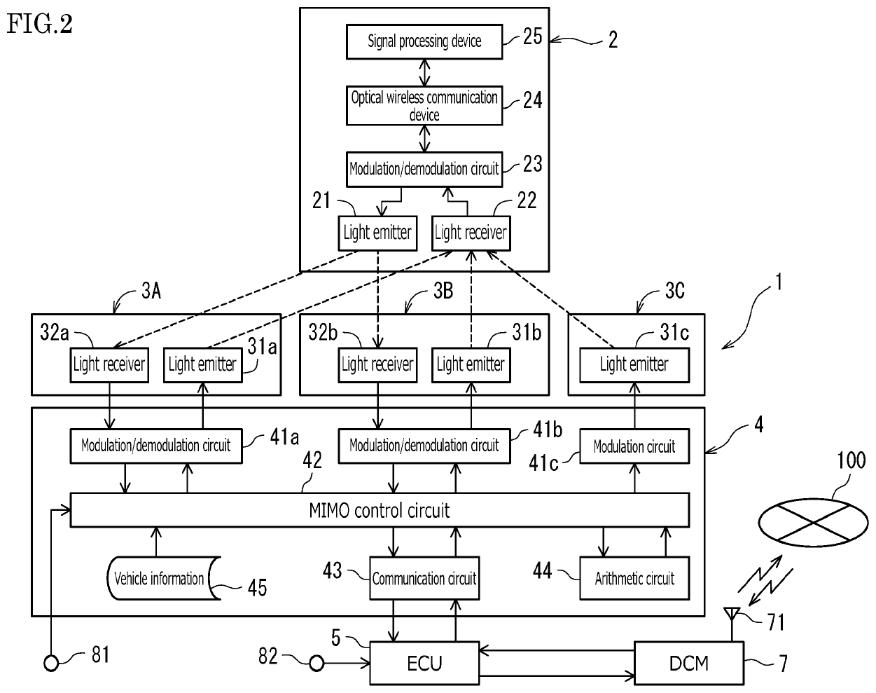

FIG. 1 is a diagram schematically illustrating a configuration of a vehicle communication system 1 according to this embodiment. FIG. 2 is a block diagram indicating the vehicle communication system 1. As shown in FIG. 1, the vehicle communication system 1 according to this embodiment is built as a communication system in which information is sent from and received by a terminal device 2 in the interior of a vehicle (for example, a smartphone or the like carried by an occupant).

Specifically, the vehicle communication system 1 includes: a plurality of (in this embodiment, three) light source devices 3A, 3B and 3C as communication devices; a body ECU (Electronic Control Unit) 4; an ECU 5 (an ECU including, for example, a gateway ECU); and a DCM (Data Communication Module) 7. Hereinafter, the light source device indicated in the drawings by the reference sign “3A” is referred to as a first light source device 3A, the light source device indicated in the drawings by the reference sign “3B” is referred to as a second light source device 3B, and the light source device indicated in the drawings by the reference sign “3C” is referred to as a third light source device 3C.

The light source devices 3A, 3B and 3C are connected to the body ECU 4 respectively by power distribution lines L1A, L1B and L1C. The power distribution lines L1A, L1B and L1C not only supply power to the respective light source devices 3A, 3B and 3C (i.e. power supply for lighting), but also perform power line communication (PLC) between the body ECU 4 and the light source devices 3A, 3B and 3C. In the vehicle communication system 1 according to this embodiment, the first light source device 3A includes a light emitter 31a and a light receiver 32a while the second light source device 3B includes a light emitter 31b and a light receiver 32b so as to send and receive optical signals. The third light source device 3C includes only a light emitter 31c so as to only send optical signals. However, all the light source devices 3A, 3B and 3C may respectively include the light emitters and the light receivers so as to send and receive optical signals. Also, the number of the light source devices applied to the vehicle communication system 1 is not limited to three.

Also, by connecting the body ECU 4, the ECU 5 and the DCM 7 by a signal line L2 (i.e. wired connection), the two-way communication can be performed via an in-vehicle network according to communication protocols such as CAN (Controller Area Network), Ethernet and the like. The body ECU 4, the ECU 5 and the DCM 7 are realized by a computer including a CPU (Central Processing Unit), a RAM (Random Access Memory), a ROM (Read Only Memory), a clock generator, an input-output interface, a communication interface, and internal buses.

Hereinafter, the terminal device 2 and the respective components of the vehicle communication system 1 will be described.

(Terminal Device)

The terminal device 2 is, for example, a portable terminal such as a smartphone carried by an occupant in a vehicle. The terminal device can perform optical wireless communication (Li-Fi: registered trademark) with the light source devices 3A, 3B and 3C.

As shown in FIG. 2, the terminal device 2 includes: a light emitter 21; a light receiver 22; a modulation/demodulation circuit 23; an optical wireless communication device 24; and a signal processing device 25.

Specifically, an LED (Light Emitting Diode) can be adopted as the light emitter 21. Also, a PD (Photodiode) can be adopted as the light receiver 22. Thus, a light flashing pattern emitted by the light emitter 21 can be transmitted, as a transmission signal (digital signal), to the first light source device 3A and the second light source device 3B. Also, a light flashing pattern detected by the light receiver 22 can be received, as a reception signal, from the light source devices 3A, 3B and 3C.

Here, the advantages of Li-Fi are briefly described. Li-Fi can realize the transfer rate not less than 5 Gbps, which means that information can be sent and received at extremely high speed. The light used for Li-Fi is not limited to the visible light. The infrared light and the ultraviolet light may also be used. Thus, when it is not preferable to irradiate the inside of the vehicle with the visible light, for example, in the daytime, the light emitted from the light source devices 3A, 3B and 3C may be changed to the infrared light or the ultraviolet light. In this way, it is possible to perform the optical wireless communication while meeting the requirement of an occupant (i.e. the requirement not to irradiate the inside of the vehicle with the visible light). Also, since Li-Fi does not cause radio interference, stable communication can be achieved. Furthermore, since Li-Fi does not generate any electromagnetic wave, electronic devices mounted on the vehicle are not affected, which leads to realization of stable operations of the electronic devices. In the configuration of this embodiment, it is possible to perform wireless communication (optical wireless communication) between the terminal device 2 and the respective light source devices 3A, 3B and 3C using Li-Fi having various advantages as described above.

The modulation/demodulation circuit 23 modulates optical signals to be transmitted to the light source devices 3A and 3B, and demodulates optical signals received from the light source devices 3A, 3B and 3C. The optical wireless communication device 24 generates an optical signal to be transmitted to the first light source device 3A and the second light source device 3B, and outputs the generated optical signal to the modulation/demodulation circuit 23. Also, the optical wireless communication device 24 receives, from the modulation/demodulation circuit 23, information after demodulation of the optical signal from the respective light source devices 3A, 3B and 3C. The signal processing device 25 sends information to and receives information from the optical wireless communication device 24. Thus, the signal processing device 25 performs, based on information (communication information) received from the optical wireless communication device 24: processing to output image display or the like to a user interface such as a display device (monitor) provided in the terminal device 2;

and generation of information based an operation when an occupant operates the terminal device 2 (i.e. information on operation instructions from the occupant).

(Light Source Device)

The light source devices 3A, 3B and 3C respectively perform optical wireless communication (Li-Fi) with the terminal device 2. Also, since the light source devices 3A, 3B and 3C are connected to the body ECU 4 by the respective power distribution lines L1A, L1B and L1C as described above, the light source devices 3A, 3B and 3C can send information to and receive information from the body ECU 4 (i.e. can communicate with each other) by power line communication (PLC) in which communication signals are superimposed on the power distribution lines L1A, L1B and L1C.

Also, as described above, the first light source device 3A and the second light source device 3B respectively include: the light emitters 31a and 31b; and the light receivers 32a and 32b. Also, the third light source device 3C includes the light emitter 31c. In particular, an LED can be adopted as the light emitters 31a, 31b and 31c, and a PD can be adopted as the light receivers 32a and 32b. Thus, it is possible to transmit the light flashing pattern to the terminal device 2 as a transmission signal (digital signal) by operations of a drive circuit (Tx driver) provided in each of the light emitters 31a, 31b and 31c. Also, it is possible to receive the light flashing pattern from the terminal device 2 as a reception signal by operations of a drive circuit (Rx driver) provided in each of the light receivers 32a and 32b.

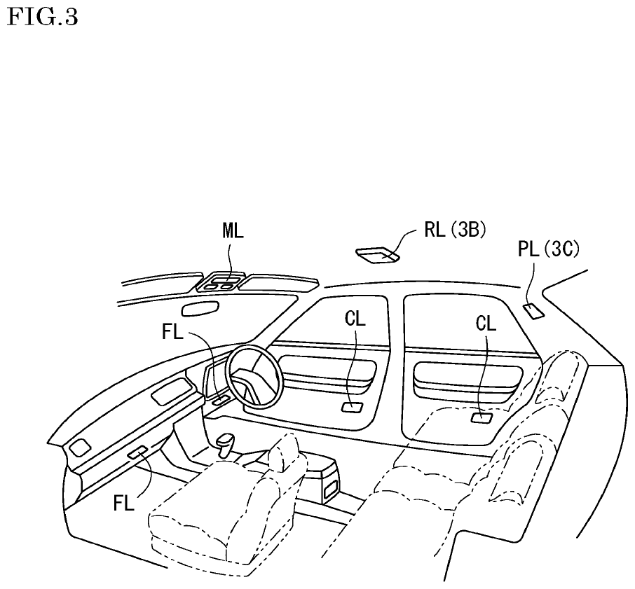

FIG. 3 is a diagram illustrating an example of installation locations of the in-vehicle light source devices 3A, 3B and 3C (in this diagram, the seats in the vehicle are indicated by the virtual lines). As shown in FIG. 3, the vehicle includes, in the inside thereof, the lamps such as a room lamp RL, a map lamp ML, a personal lamp PL, a foot lamp FL, and a courtesy lamp CL. The light source devices 3A, 3B and 3C can be applied to any of these lamps. In this embodiment, the light source devices 3A, 3B and 3C are applied to the room lamp RL and the left and right personal lamps PL among the above lamps.

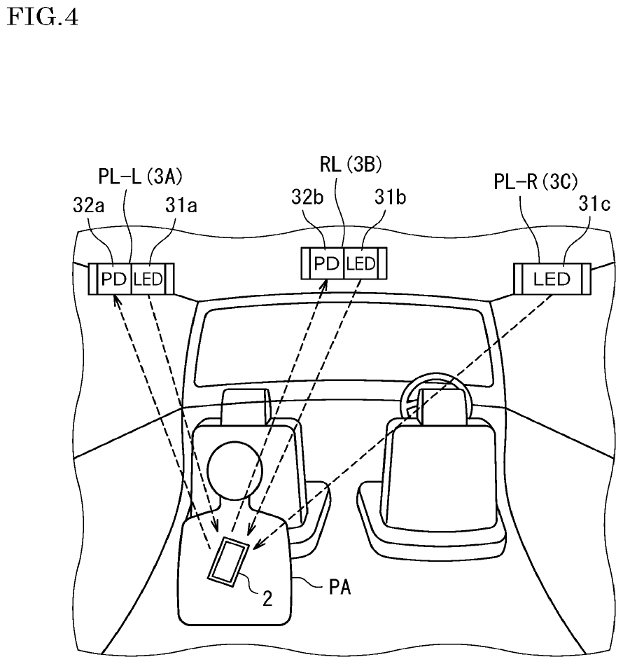

FIG. 4 is a schematic diagram explaining a communication state in the vehicle in this embodiment. That is, the light source devices 3A, 3B and 3C are applied to the room lamp RL and the left and right personal lamps PL-L and PL-R. More specifically, the first light source device 3A including the light emitter 31a and the light receiver 32a is applied to the left personal lamp PL-L. The second light source device 3B including the light emitter 31b and the light receiver 32b is applied to the room lamp RL. The third light source device 3C including only the light emitter 31c is applied to the right personal lamp PL-R.

Examples of other lamps that can be adopted as the light source devices 3A, 3B and 3C in the vehicle communication system 1 include; lamps on a meter panel; and lamps on a center console.

(Body ECU)

As previously described, the body ECU 4 is connected to the light source devices 3A, 3B and 3C by the power distribution lines L1A, L1B and L1C, and thus is capable of sending information to/receiving information from (i.e. communicating with) the light source devices 3A, 3B and 3C by power line communication using the power distribution lines L1A, L1B and L1C.

Also, as shown in FIG. 2, the body ECU 4 includes: modulation/demodulation circuits 41a and 41b respectively corresponding to the first light source device 3A and the second light source device 3B; a modulation circuit 41c corresponding to the third light source device 3C; a MIMO control circuit (control part) 42; a communication circuit 43; an arithmetic circuit 44; and a database 45 in which vehicle information is stored.

The modulation/demodulation circuits 41a and 41b modulate signals to be transmitted to the first light source device 3A and the second light source device 3B, and demodulate signals received from the first light source device 3A and the second light source device 3B. That is, the modulation/demodulation circuits 41a and 41b modulate/demodulate the communication signals sent/received by being superimposed on the power distribution lines L1A and L1B. The modulation circuit 41c modulates signals to be transmitted to the third light source device 3C. That is, the modulation circuit 41c modulates the communication signals sent by being superimposed on the power distribution line L1C.

The MIMO control circuit 42 sets a main light source device for the optical wireless communication (i.e. a communication device mainly performing wireless communication with the terminal device 2), more specifically, sets a communication path mainly performing communication by optical wireless communication based on operations to select the light source device (described later) in order to perform the optical wireless communication between the terminal device 2 and the light source devices 3A, 3B and 3C. Generally, the MIMO is a communication method of the wireless communication, in which both of the sender and receiver use a plurality of antennas (in this embodiment, the light emitter and the light receiver) and perform the same communication at the same frequency band so as to increase the communication speed and improve the communication quality. For this reason, the terminal device 2 is provided with a plurality of antennas (the light emitter and the light receiver), although they are not shown in the drawings. Operations to set the main light source device (i.e. operations to select the light source device) for the optical wireless communication are described later, which are operations at the time of performing optical wireless communication between the terminal device 2 and the respective light source devices 3A, 3B and 3C using MIMO method.

The communication circuit 43 is connected to the ECU 5 (wired connection), and sends information to and receives information from the ECU 5.

The arithmetic circuit 44 sends information to and receives information from the MIMO control circuit 42. The signal being sent and received is a synthesized wave of the signals received by the first light source device 3A and the second light source device 3B. The arithmetic circuit 44 performs, for example, arithmetic processing to extract each piece of communication information from the synthesized wave.

The database 45 stores, as vehicle information, information on each location of the light source devices 3A, 3B and 3C, information on seat layout in the vehicle, and information on respective specifications (such as an LED output).

Also, a seating sensor (detection part) 81 is connected to the body ECU 4. The seating sensor 81 is provided on each seat in the vehicle, and it is constituted of a weight sensor that detects whether an occupant sits in the seat. More specifically, when an occupant sits in the seat, the seating sensor 81 turns ON due to the weight of the occupant. This ON signal is transmitted to the body ECU 4 (the MIMO control circuit 42 of the body ECU 4). Thus, it is possible to determine in which seat the occupant is sitting among the respective seats in the vehicle.

(ECU)

The ECU 5 is connected to the DCM 7 and the body ECU 4 via the in-vehicle network to relay communication between the above devices. Also, the ECU 5 can be connected to a predetermined network (internet) 100 outside of the vehicle via the DCM 7.

Also, a vehicle-mounted camera (an inside camera; detection part) 82 is connected to the ECU 5. The vehicle-mounted camera 82 is an existing product that is provided, for example, on the ceiling part in the vehicle to take an image of the interior of the vehicle. The image in the vehicle taken by the vehicle-mounted camera 82 is transmitted to the body ECU 4 via the ECU 5. The image of the interior of the vehicle is not only used as information for monitoring the interior of the vehicle (for example, for the purpose of antitheft), but also used as information for determining in which seat an occupant is sitting among the respective seats in the vehicle.

(DCM)

The DCM 7 is a communication device capable of performing two-way communication via the predetermined network 100 including the mobile telephone network having a number of base stations and the internet network. Specifically, the DCM 7 can communicate with the outside of the vehicle (for example, the network 100 such as internet) via a vehicle external antenna 71. In particular, the DCM 7 performs wireless communication via the communication line such as 3G (Generation), 4G, LTE, and 5G. In brief, the DCM 7 can be connected to the network 100 via any of the above listed communication lines.

Thus, the terminal device 2 and the respective components 3, 4, 5 and 7 in the vehicle communication system 1 were described.

—Operations to Select Light Source Device—

When the optical wireless communication is performed between the terminal device 2 and the respective light source devices 3A, 3B and 3C in the vehicle as described above, there is a high possibility that any obstacles (occupants and/or objects) exist between the terminal device 2 and the light source devices 3A, 3B and 3C to interfere with the communication, since the interior of the vehicle is generally a relatively small space. Consequently, the quality of the wireless communication may be degraded due to the obstacles. Especially in the optical wireless communication, when an occupant interposes between the terminal device 2 and the light source device 3A positioned in a certain location (i.e. on the optical path between them), the quality of the optical wireless communication between the terminal device 2 and the light source device 3A is degraded. Furthermore, in the case of the vehicle, a light receiving element may be saturated due to a short distance between the terminal device 2 and the light source device 3A, which may also degrade the quality of the optical wireless communication.

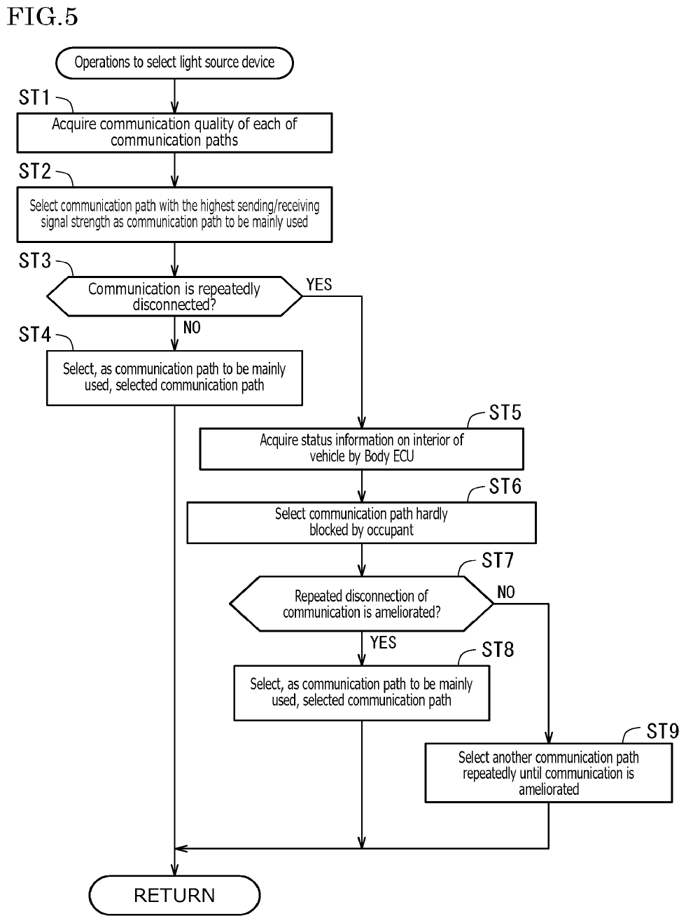

In this embodiment taking into account the above circumstances, the wireless communication with high quality is realized in the interior of the vehicle by MIMO optical wireless communication by selecting, from the plurality of light source devices 3A, 3B and 3C, a light source device mainly performing the wireless communication with the terminal device 2 based on the state of the occupant (position information on the occupant) in the vehicle, which is detected by information from the seating sensor 81 and the vehicle-mounted camera 82. Hereinafter, the operations to select the light source device are described referring to the flowchart in FIG. 5. In the explanation below, a situation is exemplarily described, in which an occupant PA interferes with the communication between the first light source device 3A applied to the left personal lamp PL-L and the terminal device 2 (see FIG. 4). Also, the flowchart indicated in FIG. 5 is repeatedly performed by the MIMO control circuit 42 at a predetermined time interval.

In step ST1, information on communication quality of each of a plurality of communication paths is acquired. Specifically, the following information on communication quality is acquired, as shown in FIG. 4: the communication quality of the communication path between the first light source device 3A and the terminal device 2; the communication quality of the communication path between the second light source device 3B and the terminal device 2; and the communication quality of the communication path between the third light source device 3C and the terminal device 2.

In step ST2, a communication path with the highest sending/receiving signal strength (i.e. a communication path with the highest sending/receiving signal strength when it is assumed, for example, that there is no obstacle) is selected (temporarily selected) as the communication path to be mainly used based on the acquired information on the communication quality (operations to select the communication path by the MIMO control circuit 42). In the case shown in FIG. 4, the first light source device 3A, which is located closest (i.e. at the shortest relative distance) to the terminal device 2 carried by the occupant PA is selected, and thus the communication path between the first light source device 3A and the terminal device 2 is selected.

In step ST3, the optical wireless communication is performed using the thus selected communication path (the communication path between the first light source device 3A and the terminal device 2), and it is determined whether this communication is repeatedly disconnected or not (operations to evaluate the communication quality in the present invention). In other words, it is determined whether the optical wireless communication is stably performed or not using the selected communication path.

When the communication is not repeatedly disconnected and thus the optical wireless communication can be stably performed using the selected communication path (i.e. when the occupant PA does not interfere with the communication between the first light source device 3A and the terminal device 2), it is determined to be “NO” in step ST3, and the procedure advances to step ST4 where the selected communication path is continuously selected as the communication path to be mainly used. That is, among the plurality of light source devices 3A, 3B and 3C, the first light source device 3A is selected as the light source device to perform mainly the optical wireless communication with the terminal device 2.

In the communication path using the selected light source device (i.e. the light source device that mainly performs the optical wireless communication; the first light source device 3A in this case), the functions related to the optical wireless communication such as “precoding”, “spatial multiplexing”, and “diversity coding” are largely weighted compared to the communication paths of the other light source devices 3B and 3C.

Precoding is a technique to weight the signal before sending in MIMO method depending on the wireless transmission path. In other words, it is processing to multiply the stream by the transmission weight so that the sending signals are distributed into the respective antennas. More specifically, it is a technique to send the same signals but weighted to have appropriate phases from the respective antennas so that the maximum signal power is received by the receiver. That is, in the above-described case, the signals in the optical wireless communication by the first light source device 3A are weighted.

The spatial multiplexing is a technique to divide a signal with a high transfer rate into a plurality of streams with low transfer rates so as to send the respective streams from the transmission antennas to the respective antennas at the same frequency channels. In this way, it is possible to increase the communication path capacity with a high signal-to-noise ratio. That is, in the above-described case, the sending signal from the first light source device 3A is spatially multiplexed.

Diversity coding is a technique to send a single stream, unlike the spatial multiplexing. However, in this case the signal is encoded by a technique of space-time coding. The signal is transmitted from the respective antennas as a perfect Walsh Code. In the diversity coding method, it is possible to enhance the diversity of the signal using fading in a plurality links of antennas. That is, in the above-described case, the sending signal from the first light source device 3A is encoded by diversity coding.

On the other hand, when the optical wireless communication is performed using the selected communication path and the communication is repeatedly disconnected, then it is determined to be “YES” in step ST3. In this case, the information (information on the result of the operations to evaluate the communication quality) is fed back to the MIMO control circuit 42. Thus, in step ST5, the body ECU acquires status information on the interior of the vehicle. Specifically, outputs from the seating sensor 81 and the vehicle-mounted camera 82 are received by the body ECU 4. Thus, the body ECU 4 determines in which seat the occupant PA is sitting among the respective seats in the vehicle.

After that, in step ST6, a communication path that is hardly blocked by the occupant PA is selected among the communication paths based on the location of the terminal device 2, the respective locations of the light source devices 3A, 3B and 3C (position information obtained from the database 45), and the location of the occupant PA. In the case shown in FIG. 4, since the communication path between the first light source device 3A and the terminal device 2 is blocked by the occupant PA, the communication path between the second light source device 3B and the terminal device 2 is, for example, selected.

In step ST7, it is determined whether the repeated disconnection is ameliorated and furthermore the stable optical wireless communication can be performed by this optical wireless communication using the selected communication path (the operations to evaluate the communication quality in the present invention).

When the repeated disconnection is ameliorated and it is determined to be “YES” in step ST7, the procedure advances to step ST8 where the selected communication path is selected as the communication path to be mainly used. That is, among the plurality of light source devices 3A, 3B and 3C, the second light source device 3B is selected as the light source device to mainly perform the optical wireless communication with the terminal device 2. In the communication path using the selected light source device (i.e. the light source device that mainly performs the optical wireless communication; the second light source device 3B in this case), the functions related to the optical wireless communication such as “precoding”, “spatial multiplexing”, and “diversity coding” are largely weighted compared to the communication paths of the other light source devices 3A and 3C, similarly to the above-described case.

On the other hand, when the repeated disconnection is not ameliorated and it is determined to be “NO” in step ST7, the procedure advances to step ST9 where another communication path is selected repeatedly until the repeated disconnection is ameliorated. In this embodiment, the first light source device 3A and the second light source device 3B include respectively the light emitters 31a and 31b and the light receivers 32a and 32b while the third light source device 3C includes only the light emitter 31c. Thus, when the communication is repeatedly disconnected between the terminal device 2 and the first and second light source devices 3A and 3B, and furthermore when the repeated disconnection is ameliorated in the communication between the terminal device 2 and the third light source device 3C, the third light source device 3C capable of one-way communication is selected as the light source device to mainly perform the optical wireless communication with the terminal device 2 while the other light source devices 3A and 3B are used as the light source devices for two-way communication. In the case where the third light source device 3C includes the light emitter and the light receiver, the two-way communication is performed also between the third light source device 3C and the terminal device 2. When all the light source devices 3A, 3B and 3C are subjected to the operations to select the communication path, the communication path with the highest communication quality (in which the disconnection most unlikely occurs) is selected, among the communication paths, as the communication path to be mainly used. That is, in the above-described case, when the communication is repeatedly disconnected also between the third light source device 3C and the terminal device 2, the communication path with the highest communication quality for the communication between the light source device and the terminal device 2 is selected among the communications between the terminal device 2 and the respective light source devices 3A, 3B and 3C.

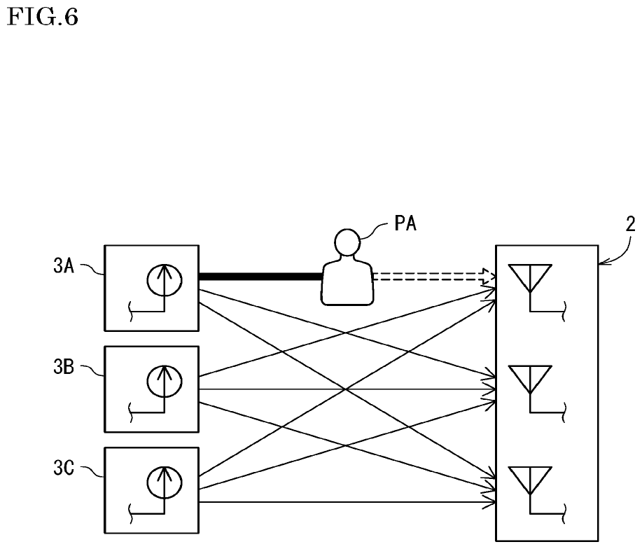

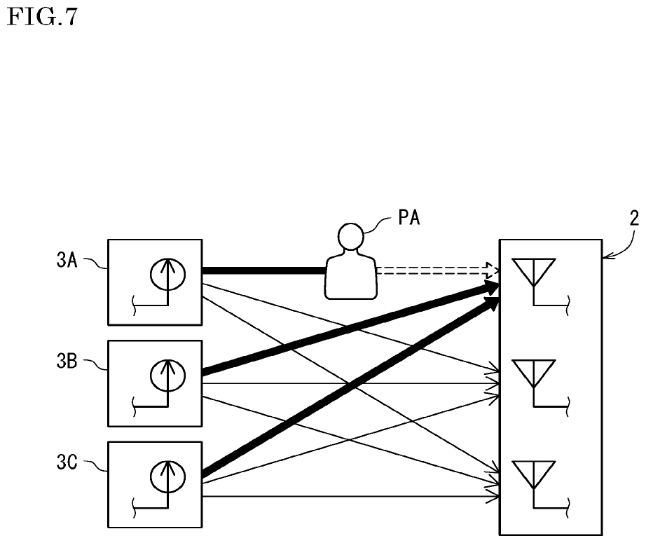

The above operations are repeatedly performed. Therefore, as exemplarily shown in FIG. 6 (a schematic diagram indicating the communication state between the terminal device 2 and the respective light source devices 3A, 3B and 3C before the operations to select the light source device are completed), when the occupant PA exists on the communication path of the first light source device 3A and thus the communication using this communication path is repeatedly disconnected (see the arrow indicated by the dashed line), the communication paths of the second light source device 3B and the third light source device 3C are selected as the communication paths to be mainly used after the operations to select the light source device are completed as shown in FIG. 7. Thus, the wireless communication with high quality can be realized (see the arrows indicated by the thick line in FIG. 7). In FIG. 7, the communication path using the second light source device 3B and the communication path using the third light source device 3C are both selected as the communication paths to be mainly used. However, either one of the communication paths may be selected as the communication path to be mainly used. Also, in FIGS. 6 and 7, the terminal device 2 includes a plurality of light receivers. However, the terminal device 2 that includes only one light receiver is also in the scope of the technical idea of the present invention.

### Effects of Embodiment

As described above, in this embodiment, the light source device to mainly perform the wireless communication with the terminal device 2 is selected among the plurality of light source devices 3A, 3B and 3C capable of performing wireless communication (optical wireless communication) with the terminal device 2 based on the state of the occupant PA in the interior of the vehicle. In this way, it is possible, as the whole system, to realize wireless communication with high quality between the terminal device 2 and the plurality of light source devices 3A, 3B and 3C. Especially, since the vehicle is mostly made of metal, it is difficult for radio wave to reach the inside of the vehicle by the communication mode using radio wave. However, in this embodiment, since the communication with the outside of the vehicle is possible by the vehicle external antenna 71 and furthermore the terminal device 2 communicates with the light source devices 3 by the optical wireless communication by the MIMO method, it is possible to obtain a good communication state even in the vehicle.

Also in this embodiment, it is determined in which seat the occupant PA is sitting among the respective seats in the vehicle by the signals from the seating sensor 81 and by the images of the interior of the vehicle taken by the vehicle-mounted camera 82. Therefore, it is possible to detect accurately the position of the occupant PA in the vehicle, and furthermore to correctly determine with which light source device of the plurality of light source devices 3A, 3B and 3C the occupant PA interferes. As a result, it is possible to improve reliability of the selection of the communication device that mainly performs the wireless communication with the terminal device 2.

In this embodiment, the operations to evaluate the communication quality of the wireless communication between the selected light source device and the terminal device 2 are performed, and the result of the operations to evaluate the communication quality is fed back to the body ECU 4 (the MIMO control circuit 42). Then, when the predetermined communication quality is not achieved, the wireless communication between the terminal device 2 and the respective communication devices 3B and 3C are sequentially subjected to the operations to evaluate the communication quality until the predetermined communication quality is obtained. Thus, the communication device 3B (3C) that wirelessly communicates with the terminal device 2 when the predetermined communication quality is obtained is selected as the communication device 3B (3C) to mainly perform the wireless communication with the terminal device 2. Thus, it is possible to select the communication device that achieves the predetermined communication quality with the terminal device 2 among the plurality of communication devices 3A, 3B and 3C. As a result, it is possible to improve reliability of the wireless communication with high quality between the terminal device 2 and the respective light source devices 3A, 3B and 3C.

—Variation—

Here, a variation is described. In this variation, the procedure of operations to select the light source device differs from that in the above-described embodiment. Since the other configurations and operations are the same as those in the above-described embodiment, only the procedure of operations to select the light source device is described here.

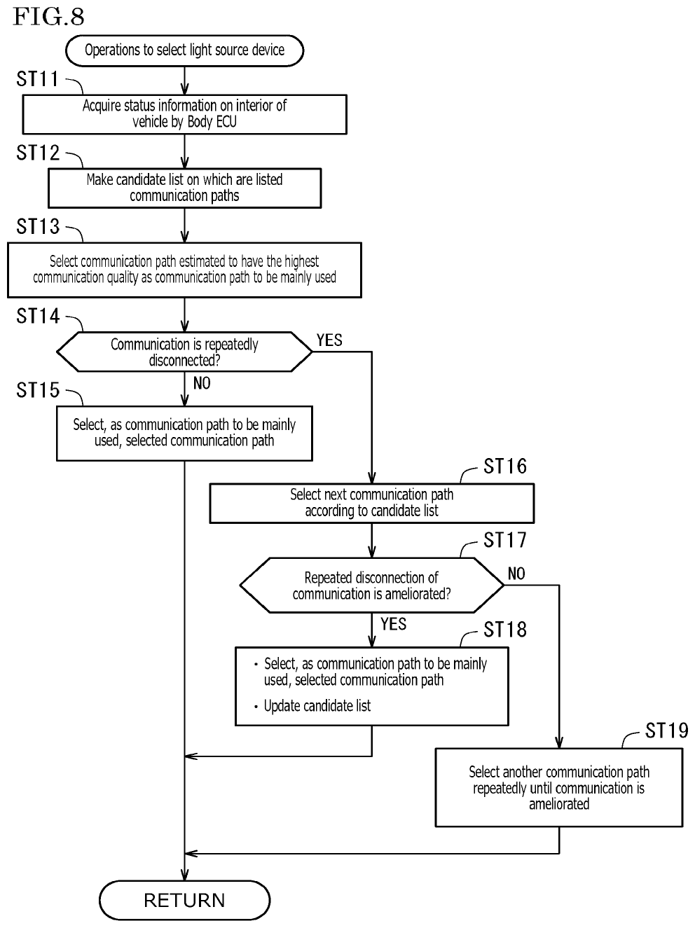

FIG. 8 is a flowchart indicating a procedure of operations to select the light source device according to the variation. In the operations to select the light source device according to the variation, firstly, in step ST11, the body ECU 4 acquires status information on the interior of the vehicle. Specifically, outputs from the seating sensor 81 and the vehicle-mounted camera 82 are received by the body ECU 4. Thus, the body ECU 4 determines in which seat the occupant PA is sitting among the respective seats in the vehicle.

After that, in step ST12, a candidate list is made, on which are listed the communication paths estimated to have high communication quality among the plurality of communication paths. On the candidate list made here, the communication path estimated to have the highest communication quality among the plurality of communication paths is set to the first communication path, and the communication path estimated to have the lowest communication quality is set to the last communication path. This candidate list may be made every time the operations to select the light source device are performed based on the status information on the interior of the vehicle acquired in step ST11, or may be learned from the previously made lists, or further may be artificially made in advance.

After that, the procedure advances to step ST13 where the communication path estimated to have the highest communication quality is selected (temporarily selected) as the communication path to be mainly used. In the case shown in FIG. 4, the second light source device 3B is selected, with which there is a low possibility that the occupant PA interferes with the communication. Accordingly, the communication path between the second light source device 3B and the terminal device 2 is selected.

In step ST14, the optical wireless communication is performed using the thus selected communication path (the communication path between the second light source device 3B and the terminal device 2), and it is determined whether this communication is repeatedly disconnected or not. In other words, it is determined whether the optical wireless communication is stably performed or not using the selected communication path.

When the communication is not repeatedly disconnected and thus the optical wireless communication can be stably performed using the selected communication path, it is determined to be “NO” in step ST14, and the procedure advances to step ST15 where the selected communication path (i.e. the communication path estimated to have the highest communication quality) is continuously selected as the communication path to be mainly used. That is, among the plurality of light source devices 3A, 3B and 3C, the second light source device 3B is selected as the light source device to mainly perform the optical wireless communication with the terminal device 2.

In the communication path using the selected light source device (i.e. the light source device that mainly performs the optical wireless communication; the second light source device 3B in this case), the functions related to the optical wireless communication such as “precoding”, “spatial multiplexing”, and “diversity coding” are largely weighted compared to the communication paths of the other light source devices 3A and 3C, similarly to the above-described embodiment.

On the other hand, when the optical wireless communication is performed using the selected communication path and the communication is repeatedly disconnected, then it is determined to be “YES” in step ST14. In this case, the procedure advances to step ST16 where the next (the next candidate) communication path is selected according to the candidate list as described above. In the case shown in FIG. 4, the communication path between the first light source device 3A and the terminal device 2 is, for example, selected.

In step ST17, it is determined whether the repeated disconnection is ameliorated and furthermore the stable optical wireless communication can be performed by the optical wireless communication using the selected communication path.

When the repeated disconnection is ameliorated and it is determined to be “YES” in step ST17, the procedure advances to step ST18 where the selected communication path is selected as the communication path to be mainly used. That is, among the plurality of light source devices 3A, 3B and 3C, the first light source device 3A is selected as the light source device to mainly perform the optical wireless communication with the terminal device 2. In the communication path using the selected light source device (i.e. the light source device that mainly performs the optical wireless communication; the first light source device 3A in this case), the functions related to the optical wireless communication such as “precoding”, “spatial multiplexing”, and “diversity coding” are largely weighted compared to the communication paths of the other light source devices 3B and 3C, similarly to the above-described case. Also in step ST18, the candidate list is updated. That is, the candidate list is updated such that the communication path using the first light source device 3A is set to the first communication path. Therefore, when the next operations to select the light source device are performed, the light source device is selected according to the thus updated candidate list.

On the other hand, when the repeated disconnection is not ameliorated and it is determined to be “NO” in step ST17, the procedure advances to step ST19 where the next (the next candidate) communication path is selected according to the candidate list, repeatedly, until the repeated disconnection is ameliorated. In this variation also, when the communication is repeatedly disconnected between the terminal device 2 and the first and second light source devices 3A and 3B, and furthermore when the repeated disconnection is ameliorated by the communication between the terminal device 2 and the third light source device 3C, the third light source device 3C capable of one-way communication is selected as the light source device to mainly perform the optical wireless communication with the terminal device 2 while the other light source devices 3A and 3 B are selected as the light source devices for two-way communication. In the case where the third light source device 3C includes the light emitter and the light receiver, the two-way communication is performed also between the third light source device 3C and the terminal device 2. When all the light source devices 3A, 3B and 3C are subjected to the operations to select the communication path, the communication path with the highest communication quality (in which the disconnection most unlikely occurs) is selected, among the communication paths, as the communication path to be mainly used.

The above operations are repeatedly performed.

In this variation also, it is possible, as the whole system, to realize wireless communication with high quality between the terminal device 2 and the plurality of light source devices 3A, 3B and 3C, similarly to the above-described embodiment.

### Other Embodiments

The present invention is not limited to the above-described embodiment and the variation. All modifications and changes that come within the meaning and range of equivalency of the claims are intended to be embraced therein.

For example, in the embodiment and the variation as described above, the communication system for transport means (i.e. the vehicle communication system 1) is applied to an automobile. However, the present invention is not limited thereto. The system 1 can be applied to various transport means such as a transit bus, a railroad vehicle, an airplane, and a vessel.

Also in the embodiment and the variation as described above, a smartphone is exemplarily explained as the terminal device 2 carried by the occupant. However, the present invention is not limited thereto. The vehicle communication system 1 may be built as a system to perform wireless communication (such as optical wireless communication) between various components installed in the interior of the vehicle (for example, a car navigation device, an audio device, and an air conditioning device) and the light source devices 3A, 3B and 3C.

Also, the vehicle communication system 1 of the present invention can be introduced (retrofitted) in a vehicle on which the vehicle communication system of the present invention is not mounted (i.e. an existing vehicle).

Also in the embodiment and the variation as described above, the seating sensor 81 and the vehicle-mounted camera 82 are exemplarily described as the detection part to detect the state of the occupant in the interior of the vehicle. In place of or in addition to the above sensor 81 and camera 82, it is possible to use a seat belt sensor for detecting whether the seat belt provided on the seat is worn (i.e. the seat belt sensor that outputs an “ON” signal at the time when the tongue plate of the seat belt is engaged with the buckle).

Also, as the wireless communication mode of the present invention in the interior of the vehicle, Bluetooth may be used as mentioned above. In this case, it is necessary to provide a plurality of Bluetooth devices in the interior of the vehicle. However, the vehicle communication system 1 of the present invention can be built by installing Bluetooth in various sensors and/or in-vehicle electric devices, apart from a car navigation system in which Bluetooth is generally installed.

### INDUSTRIAL APPLICABILITY

The present invention is applicable to a vehicle communication system by which wireless communication can be performed between the outside of the vehicle and the wireless communication environment in the vehicle.

### REFERENCE SIGNS LIST

1 Vehicle communication system (communication system for transport means)
2 Terminal device
3A, 3B, 3C Light source device (communication device)
31a, 31b, 31c Light emitter
32a, 32b Light receiver
4 Body ECU
42 MIMO control circuit (control part)

What is claimed is:

1. A communication system for transport means, comprising:
a plurality of communication devices performing wireless communication with a terminal device in an interior of the transport means;
a detection part detecting a state of an occupant in the interior of the transport means; and
a control part selecting a communication device to mainly perform the wireless communication with the terminal device, among the plurality of communication devices, based on the state of the occupant in the interior of the transport means, which is detected by the detection part.

2. The communication system for transport means according to claim 1, wherein
the detection part includes at least one of the following: a seating sensor detecting whether the occupant is sitting in a seat provided in the interior of the transport means; a seat belt sensor detecting whether a seat belt provided on the seat is worn; and an inside camera taking an image of the interior of the transport means.

3. The communication system for transport means according to claim 1, wherein
operations to evaluate communication quality of the wireless communication between the terminal device and the communication device selected by the control part are performed, and
a result of the operations to evaluate the communication quality is fed back to the control part.

4. The communication system for transport means according to claim 3, wherein
when the control part determines that a predetermined communication quality is not obtained based on the result of the operations to evaluate the communication quality, which is fed back to the control part, the control part sequentially performs the operations to evaluate the communication quality of the wireless communication between the terminal device and each of the plurality of communication devices until the predetermined communication quality is obtained, and
the control part selects a communication device that wirelessly communicates with the terminal device when the predetermined communication quality is obtained as the communication device to mainly perform the wireless communication with the terminal device.

5. The communication system for transport means according to claim 1, wherein
the wireless communication performed between the terminal device and each of the plurality of communication devices is optical wireless communication.
